(19) United States
(12) Patent Application Publication
(10) Pub. No.: US 2007/0100946 A1
(43) Pub. Date: May 3, 2007

(54) Method and apparatus for facilitating generation of electronic mail

(75) Inventor: Richard John Kairis JR., Raleigh, NC (US)

Correspondence Address: IBM CORPORATION, PO BOX 12195, DEPT YXSA, BLDG 002, RESEARCH TRIANGLE PARK, NC, 27709, US

(73) Assignee: INTERNATIONAL BUSINESS MACHINES CORPORATION, ARMONK, NY (US)

(21) Appl. No.: 11/264,500

(22) Filed: Nov. 1, 2005

(51) Int. Cl. G06F 15/16

(52) U.S. Cl. 709/206

(57) ABSTRACT

A computer system, method and program code product which parses an electronic message as i is composed by a computer user for a message constituent which logically implies the presence of an attachment of a determined file type, determines whether an attachment is present, and prompts the computer user if the attachment is missing.

### FIELD AND BACKGROUND OF INVENTION

Electronic messaging through computer systems has entered the popular culture and become ubiquitous. Such messages are generically known as “email” and are exchanged between a range of apparatus, from terminals attached to mainframe system, through personal computer systems connected as clients to networks or using dial up connection, to handheld devices and smart telephones.

It is commonplace to use such an email message to transmit additional materials, known (as is the case with traditional letter correspondence) as attachments. Such attachments may be data files, photographs, drawings, or any other form of material which may be brought into digital form for transmission through digital networks.

It is also commonplace for a person generating an email message to intend the attachment of some file and to then transmit the message while failing to take the necessary steps for the file to be attached. This generates additional traffic as recipients must reply asking for the missing attachment.

### SUMMARY OF THE INVENTION

With the foregoing in mind, it is a purpose of this invention to facilitate electronic messaging where an originator or sender intends to include an attachment. More specifically, it is a purpose to provide functionality within a messaging program to determine whether an intended attachment is in fact present to be sent and to remind the sender if the sender has failed to complete the steps necessary to include the attachment.

In realizing this purpose, an electronic message being composed by a computer user is parsed for a message constituent which logically implies the presence of an attachment, a determination is made whether an attachment is present, and a response is generated to a determination that the presence of an attachment is logically implied and an attachment is absent to prompt the computer user.

### BRIEF DESCRIPTION OF DRAWINGS

Some of the purposes of the invention having been stated, others will appear as the description proceeds, when taken in connection with the accompanying drawings, in which:

FIG. 1 is an illustration of a computer system in which the present invention may be implemented;

FIG. 2 is a flow chart indicative of the steps in a method in accordance with this invention; and

FIG. 3 is an illustration of a computer readable medium bearing program code which, when executed on the system of FIG. 1 or the like, implements the program flow of FIG. 2.

### DETAILED DESCRIPTION OF INVENTION

While the present invention will be described more fully hereinafter with reference to the accompanying drawings, in which a preferred embodiment of the present invention is shown, it is to be understood at the outset of the description which follows that persons of skill in the appropriate arts may modify the invention here described while still achieving the favorable results of the invention. Accordingly, the description which follows is to be understood as being a broad, teaching disclosure directed to persons of skill in the appropriate arts, and not as limiting upon the present invention.

The present invention may be implemented in a computer system, in a method of operating a computer system, and in the form of a program product distributed for use in a computer system.

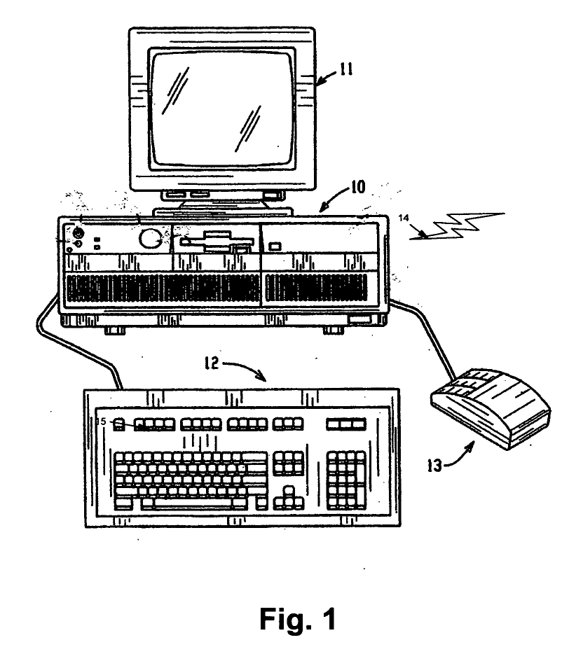

Turning first to implementation in a computer system, FIG. 1 illustrates a typical computer workstation, here a personal computer system 10. The system includes a central processor, memory accessible to the processor for storing data including programs to be executed, a display 11, input devices including a keyboard 12 and a pointing device (here shown as a mouse 13), and output devices including a network interface, often known as a NIC. The NIC may implement network connectivity by a wired connection such as an Ethernet connection or by a wireless connection (indicated at 14 in FIG. 1) such as one of the IEEE 802.11 protocols. Such computer systems come in a variety of configurations, some known as notebook systems, others as desktop or deskside systems, some known as servers, and some known as “thin clients” . The same technology appears in what are known as handheld computer systems (some of which are also known as PDAs or Personal Digital Assistants) and in certain telephone instruments such as cellular or smart telephones. The present invention finds usefulness with any such systems, and it is to be understood that the choice of one type of such system for illustration is in no way limiting upon the implementation of this invention. Persons familiar with the arts of computer technology will easily recognize the scope of applicability of what is here described and illustrated.

The computer system 10, in whatever form, has stored accessibly thereto and executing thereon an electronic mail program. Such programs are well known and are available from a number of suppliers. Examples include Lotus Notes, Microsoft Outlook and Outlook Express, Eudora, Mozilla Thunderbird, and others. Such programs typically have built in services such as spell checking, a function which can be selected for automatic operation either as a message is being created or immediately before the message is sent to a mail server. Alternatively, such program are adapted to “plug in” services to provide additional functionality and cooperation with other services such as virus checking of an outbound message.

The present invention contemplates that the service to be provided—assuring that an intended attachment is present on sending of a message—can be implemented within an electronic mail program such as those mentioned above or may be provided as an additional service either by “plug in” or by linking to an electronic mail program in use by a computer user.

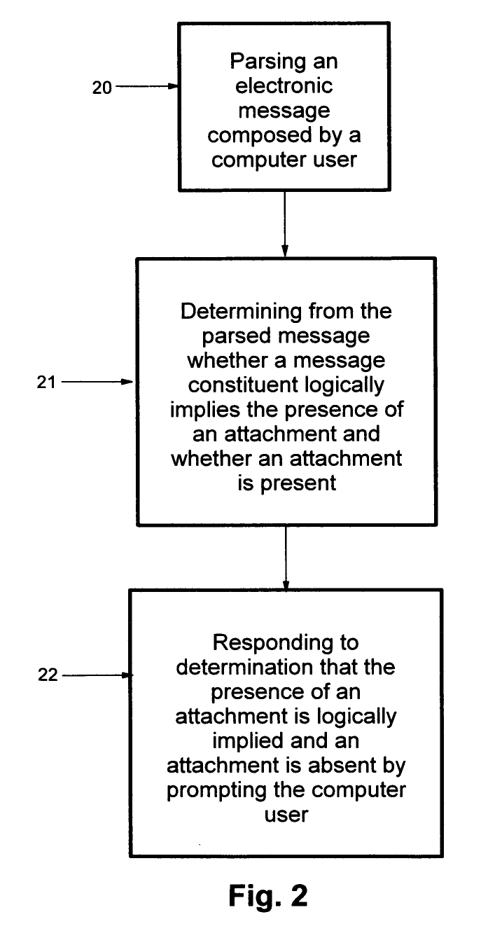

In accordance with this invention, the computer system 10 has a first logical component which parses an electronic message as it is being composed by the user; a second logical component linked with the first logical component and which determines: (a) whether a message constituent logically implies the presence of an attachment; and (b) whether an attachment is present; and a third logical component linked with the second logical component and which responds to determination that the presence of an attachment is logically implied and an attachment is absent by prompting the computer user. These logical components are indicated in FIG. 2, where the stepwise progression of their actions is illustrated.

Referring now to FIG. 2, the first logical component 20 and second logical component 21 may act together or sequentially during the composition of a message. Preferably, the parsing and determination are ongoing during the time that the user is entering the text of what will become the message, so that the prompt may be given before the user enters the “send” command. As will be understood, the first, second and third logical components desirably and preferably are software modules stored accessibly to and executing on the system 10. However, in appropriate circumstances (such as a PDA or telephone device), at least certain of the functions may be implemented in dedicated hardware devices such as special microchips.

Once a determination has been made that an attachment is intended to be present, the third logical element 22 responds by prompting the computer system user that the presence of an attachment is logically implied and yet the attachment is absent, not yet having been “attached” or identified to the email program. Such a prompt may take any one of a number of known forms. The prompt may be a flag raised in the viewing area of the program executing at the time; it may be an audible prompt such as a predetermined sound; it may be a dialog box asking the user to identify the attachment to be sent. The present invention contemplates that the prompt may take any of these forms or others not here specifically mentioned. Any response which would lead the user to awareness of the absence of an intended attachment may serve as the prompt intended here.

Further, the parsing and determination ta ino account the file types, typically indicated by a file name extension, of the intended attachment. For example, if the message being composed includes a reference to “the drawing attached”, then the present invention would seek an attachment with a file name extension indicative of a image file. Similarly if the message being composed makes reference to “the photographs from my vacation”. As further examples, should the message being composed refer to “my letter of October 15”, then the distinction would seek an attachment of a text file or word processing type, such as might have a file name extension of “.doc” or “.rft”. These examples of file name extensions and attachment distinctions can be extended, but the examples given here are believed sufficiently illustrative of the principles involved.

Viewing the process of FIG. 2 as methods, the present invention contemplates parsing an electronic message as it is composed by a computer user; determining from the parsed message whether a message constituent logically implies the presence of an attachment of a particular file type; and whether an attachment is present; and responding to determination that the presence of an attachment is logically implied and an attachment is absent by prompting the computer user. Such a method alternatively includes either context sensitive analysis or the presence of defined words and phrases in determining whether an attachment is intended.

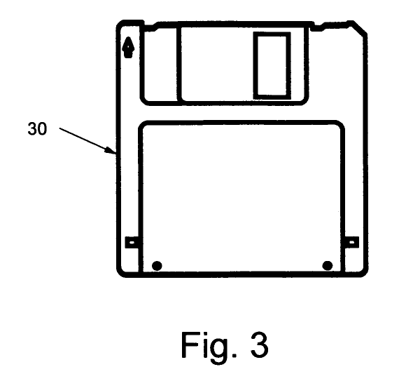

FIG. 3 shows a computer readable medium in the form of a diskette 30. As is known, such media may take a variety of forms and the diskette form is shown only as an illustration. The present invention contemplates that program code will be written which implements the method described above when executing on a system such as the system 10 or its equivalents. Thus a method is producing computer executable program code; providing the program code to be deployed to and executed on a computer system such as by loading onto the medium 30. The program code in accordance with this invention comprises instructions which cause the system executing the code to parse an electronic message as it is being composed by a computer user; determine from the parsed message whether a message constituent logically implies the presence of an attachment of a determined file type and whether an attachment is present; and respond to determination that the presence of an attachment is logically implied and an attachment is absent by prompting the computer user.

As with the method described above, the program product alternatively uses either context sensitive analysis or the presence of defined words and phrases in determining whether an attachment is intended.

In the drawings and specifications there has been set forth a preferred embodiment of the invention and, although specific terms are used, the description thus given uses terminology in a generic and descriptive sense only and not for purposes of limitation.

What is claimed is:

1. Method comprising:
parsing an electronic message as it is being composed by a computer user;
determining from the parsed message:
(a) whether a message constituent logically implies the presence of an attachment; and
(b) whether an attachment of a designated file type is present; and
responding to determination that the presence of an attachment is logically implied and an attachment is absent by prompting the computer user.

2. Method according to claim 1 wherein the determination of an implication that an attachment is present uses context sensitive analysis.

3. Method according to claim 1 wherein the determination of an implication that an attachment is present responds to the presence of defined words and phrases.

4. Method according to claim 1 further comprising distinguishing among anticipated file attachments in text formats and in image formats.

5. Method according to claim 4 wherein distinctions are drawn among file name extensions.

6. Method comprising:
producing computer executable program code;
providing the program code to be deployed to and executed on a computer system;
the program code comprising instructions which:
parses an electronic message as it is being composed by a computer user;
determines from the parsed message:
(a) whether a message constituent logically implies the presence of an attachment; and
(b) whether an attachment of a designated file type is present; and
responds to determination that the presence of an attachment is logically implied and an attachment is absent by prompting the computer user.

7. Method according to claim 6 wherein the determination of an implication that an attachment is present uses context sensitive analysis.

8. Method according to claim 6 wherein the determination of an implication that an attachment is present responds to the presence of defined words and phrases.

9. Method according to claim 6 wherein the program code distinguishes among anticipated file attachments in text formats and in image formats.

10. Method according to claim 9 wherein the program code draws distinctions among file name extensions.

11. Apparatus comprising:
a computer system usable by a user to create an electronic message;
a first logical component in the computer system which parses an electronic message as it is being composed by the user;
a second logical component in the computer system linked with said first logical component and which determines:
(a) whether a message constituent logically implies the presence of an attachment; and
(b) whether an attachment of a designated file type is present; and a third logical component in the computer system linked with said second logical component and which responds to determination that the presence of an attachment is logically implied and an attachment is absent by prompting the computer user.

12. Apparatus according to claim 11 wherein said second logical component uses context sensitive analysis.

13. Apparatus according to claim 11 wherein said second logical component responds to the presence of defined words and phrases.

14. Apparatus according to claim 11 wherein said second logical component distinguishes among anticipated file attachments in text formats and in image formats.

15. Apparatus according to claim 14 wherein said second logical component draws distinctions among file name extensions.

16. Apparatus according to claim 11 wherein said first, second and third logical components are software modules stored accessibly to and executing on said system.
